(19) United States
(12) Patent Application Publication
(10) Pub. No.: US 2006/0278067 A1
(43) Pub. Date: Dec. 14, 2006

(54) Apparatus and method for installing unit on a stringed musical instrument

(75) Inventors: Keisuke Suzuki, Hamamatsu-shi (JP); Hiroshi Imamura, Hamamatsu-shi (JP); Yoshifumi Sakai, Hamamatsu-shi (JP)

Correspondence Address: FOLEY & LARDNER, 2029 CENTURY PARK EAST, SUITE 3500, LOS ANGELES, CA, 90067, US

(73) Assignee: ROLAND CORPORATION

(21) Appl. No.: 11/147,734

(22) Filed: Jun. 8, 2005

(51) Int. Cl. G10H 1/02

(52) U.S. Cl. 84/737

(57) ABSTRACT

An apparatus for mounting a control unit on a stringed musical instrument. The apparatus is designed such that the control unit can be easily mounted on and removed from the stringed musical instrument. The apparatus provides more stable and more firm mounting of the control unit compared to similar apparatuses of the past. The apparatus facilitates the mounting of the control unit on either the front surface of the stringed musical instrument or the rear surface of the stringed musical instrument. When mounting the control unit on the front surface of the stringed musical instrument, the apparatus also facilitates mounting the control unit above the bridge of the stringed musical instrument.

### BACKGROUND OF THE INVENTION

1. Field of the Invention

Embodiments of the present invention relate, generally, to an apparatus for mounting a control unit onto various stringed musical instruments.

2. Related Art

For some time, pickups that detect string vibrations have been installed on the bodies of stringed musical instruments such as guitars and the like. Also known are main control units for the pickups (hereinafter, referred to as “main control units”) that have a volume control for controlling an output level of the pickup and a connector for interfacing with a connecting cord connects that transmits the controlled signal. This kind of main control unit is mounted on the stringed musical instrument by an attachment apparatus configured such that it is possible to mount the main control unit on various stringed musical instruments.

The pickup systems marketed by the Roland Corp. under the trademarks GK-2™ and GK-3™ are examples of the system described above. These systems have a main control unit and a holder, which is the attachment apparatus for the main control unit. An explanation will be given regarding the GK-3™ main control unit and the attachment apparatus for the main control unit in reference to FIG. 8 and FIG. 9

FIG. 8 is an exterior view drawing that shows the pickup 30 and the main control unit 20. The pickup 30, which is arranged below the strings of a guitar and the like, is the divided pickup that detects the vibrations of each string independently, and the center mark 30a that is shown located in the middle of the pickup 30 is positioned in the middle of a plurality of strings. The pickup is affixed to the body of the guitar either by screwing down the pickup using screws that are inserted into the screw holes 30b that have been disposed on both ends of the pickup 30 or by sticking double sided tape on the bottom surface of the pickup 30.

The signal that is detected by the pickup 30 is input to the main control unit 20 via the pickup cable 29. The main control unit 20 is furnished with a volume control 22, an input jack 24, a toggle switch 25, a connector 23, a down switch 26, an up switch 27, and a power indicator 28.

The volume control 22 is a variable resistor that adjusts the level of the signal that has been input via the pickup cable 29. The outputs of other pickups, with which the guitar is furnished, are input to the input jack 24 via a normal guitar cable. The toggle switch 25 toggles any one of the signals that have been input to the input jack 24, the signal, the level of which has been adjusted by the volume control 22, and a signal that is a composite of the signal that has been input to the input jack 24 and the signal, the level of which has been adjusted by the volume control 22. The toggled signal is output to an external device from the connector 23.

The down switch 26 and the up switch 27 facilitate the transmission of the signal to an external device via the connector 23. The power indicator 28, which indicates that power has been supplied to the main control emit 20 when power is supplied via the connector 23, is disposed on the side of the volume control 22.

The state in which the main control unit 20 is mounted on a stringed musical instrument such as a guitar and the like is shown in FIG. 9. The main control unit 20 is configured such that the mounting on the body 60 of the stringed musical instrument is done by a holder. The holder is one that uses two holders made of metal having an “L”shape. A first holder 51 attaches to the main control unit 20 and has a first contact plate 51 a, which contacts the front surface of the body 60 of the stringed musical instrument and a first side plate 51b, which is formed perpendicular to the first contact plate 51a and contacts the side surface of the body 60 of the stringed musical instrument. A groove 51c, into which an end pin 61 is inserted, and a bolt 52 for fastening a second holder 53 are disposed on the first side plate 51b.

The second holder 53 is configured with a second contact plate 53a, which contacts the rear surface of the body 60 of the stringed musical instrument, and a second side plate 53b, which is formed perpendicular to the second contact plate 53a and contacts the first side plate 5b of the first holder 51 running along the side surface of the body 60. A bolt 52 is formed on and extends from the side plate 5b. An elongated hole 53c, which receives the bolt 52 that has been provided on the first side plate 5b, is formed in the second side plate 53b.

To mount the main control unit 20 on the body 60 of the stringed musical instrument, first, the main control unit 20 is attached to the first holder 51. Next, an end pin 61 of the stringed musical instrument is loosened, and the groove 51c that has been formed in the first side plate 51b of the first holder 51 is inserted on the threaded section of the end pin 61. Next, the contact plate 51a of the first holder 51 is brought into contact with the front surface of the stringed musical instrument, and the end pin 61 is tightened to fasten the main control unit 20.

Next, the bolt 52 that is provided on the first side plate 51b is inserted into the elongated hole 53c in the second side plate 53b of the second holder 53, and the contact plate 53a of the second holder 53 is brought into contact with the rear surface of the stringed musical instrument. Then,.a flat washer 54 and a spring washer 55 are inserted onto the bolt 52 that is provided on the first side plate 51b, and the holder is fastened using a cap nut 56.

To remove the main control unit 20 from the body 60 of the stringed musical instrument, the cap nut 56 is loosened, and the cap nut 56, the spring washer 55, the flat washer 54, and the second holder 53 are removed from the bolt 52. Next, the end pin 61 of the stringed musical instrument is loosened, and the main control unit 20 is removed by lifting up the groove 51c of the first holder 51 along the end pin 61. The end pin 61 is, then, screwed into the body 60, returning the stringed musical instrument to a state existing before the main control unit 20 was mounted.

Bodies of conventional stringed musical instruments have been made in various shapes and with different arrangements of the volume control and the like. As a result, there have been cases in which the pickup main control unit 20 cannot be mounted on the body of the stringed musical instrument. In addition, in the past, methods such as attaching the pickup main control unit to the body of the stringed musical instrument with double-sided tape or adhesive were used. However, in many cases with these methods, the stringed musical instrument became dirty, and it was not possible to easily remove the main control unit 20.

In the methods described above, the pickup main control unit is affixed to a holder, and the holder is fastened to the body of the stringed musical instrument using the end pin of the stringed musical instrument. Because force is not applied to the body of the stringed musical instrument in the holding direction, the attachment can be weak and unstable.

In accordance with cases described above, the pickup main control unit is mounted on the body of a stringed musical instrument using a holder, and the procedure for attaching or removing the main control unit to or from the body of the stringed musical instrument is complicated.

### SUMMARY OF THE DISCLOSURE

Embodiments of the present invention solve problems as discussed above and provide a pickup main control unit attachment apparatus that can be easily mounted and removed without regard to the type of stringed musical instrument.

In order to achieve this object, a first embodiment of the present invention provides: a first holder that has a first contact plate that is affixed to the main control unit and that is in contact with the front surface or the rear surface of the stringed musical instrument; a second holder that has a second contact plate that is in contact with the rear surface or the front surface of the stringed musical instrument; and a linking element that links the first holder and the second holder such that the body of the stringed musical instrument is held in a pressed state between the first holder and the second holder.

Further, in the first embodiment, the first holder has a first side plate that is disposed roughly perpendicular to the first contact plate, and the first side plate has grooves that are disposed on both sides of the side plate extending in a direction that is perpendicular to the first contact plate. Also, the second holder has a second side plate that is disposed standing on the second contact plate, and both ends of the second side plate slide along the grooves of the first side plate. The first contact plate and first side plate are joined, perhaps forming an acute angle. The second contact plate and second side plate are joined, perhaps forming an acute angle.

Further, in the first embodiment, the apparatus has a first elastic member that adheres to the side of the first contact plate that is in contact with the stringed musical instrument or a second elastic member that adheres to the side of second contact plate that is in contact with the stringed musical instrument. The apparatus may have both first and second elastic members. Further, the elastic members may be formed from urethane foam.

Further, in the first embodiment, the first side plate has a curved surface that runs along the side surface of the stringed musical instrument. The curved surface of the first side plate may also have at least two convex portions that are in contact with the side surface of the stringed musical instrument.

In addition, the first side plate may be formed by the extrusion molding of aluminum, and the second side plate may be formed by the press molding of steel plate. The second side plate may also have a plurality of flat surfaces that run roughly along the curve of the curved surface of the first side plate. The first holder and the second holder may be linked via a hole formed in the first side plate along an axis roughly perpendicular to the first contact plate and a hole formed in the second holder. When a bolt is screwed through the holes of the first side plate and of the second holder, the body of the stringed musical instrument is held in a pressed state between the first and the second holders.

In a second embodiment of the present invention, the first holder and the second holder are formed and linked together as described in the first embodiment. However, when it is desired to install the main control unit on the front surface of the stringed musical instrument above the bridge of the stringed musical instrument, the main control unit may be attached to an attachment surface of a third holder. The third holder may have two side plates with which the third holder may be linked to the second holder. Also, an elastic member that adheres to the attachment surface may be disposed between the attachment surface and the surface of the stringed musical instrument.

### BRIEF DESCRIPTION OF THE DRAWINGS

FIG. 1a is an oblique view drawing of a main control unit using the attachment apparatus of an embodiment of the present invention, wherein the main control unit has been mounted on the front surface of the body of the stringed musical instrument; FIG. 1b is an oblique view drawing of the main control unit using the attachment apparatus of an embodiment of the present invention, wherein the main control unit has been mounted on the rear surface of the body of the stringed musical instrument;

FIG. 1c is an oblique view drawing of the main control unit using the attachment apparatus of an embodiment of the present invention, wherein the main control unit has been mounted above the bridge of the stringed musical instrument;

FIG. 2 is a disassembled, oblique view drawing of a first holder;

FIG. 3 is a disassembled, oblique view drawing of a second holder;

FIG. 4 is a disassembled, oblique view drawing of a third holder;

FIG. 5a shows a method in which the main control unit is disposed opposite to the front surface of the body of the stringed musical instrument, wherein the main control unit is fastened to the first holder;

FIG. 5b shows a method in which the main control unit is disposed opposite to the front surface of the body of the stringed musical instrument, wherein the second holder is linked to the first holder;

FIG. 5c shows a view from the rear side of the stringed musical instrument of the linking of the second and the first holders;

FIG. 6a shows a method with which the main control unit is disposed opposite to the rear surface of the body of the stringed musical instrument, wherein the main control unit is fastened to the first holder;

FIG. 6b shows a method with which the main control unit is disposed opposite to the rear surface of the body of the stringed musical instrument, wherein the second holder is linked to the first holder;

FIG. 7a shows a method in which the main control unit is disposed above the bridge of the stringed musical instrument, wherein the main control unit is fastened to the third holder;

FIG. 7b shows a method in which the main control unit is disposed above the bridge of the stringed musical instrument, wherein the second holder is linked to the first holder;

FIG. 7c shows a method in which the main control unit is disposed above the bridge of the stringed musical instrument, wherein the third holder is linked to the second holder;

FIG. 8 is a drawing that shows a conventional pickup and a main control unit; and

FIG. 9 is a drawing that shows a conventional attachment apparatus in which a main control unit is attached.

### DETAILED DESCRIPTION OF PREFERRED EMBODIMENTS

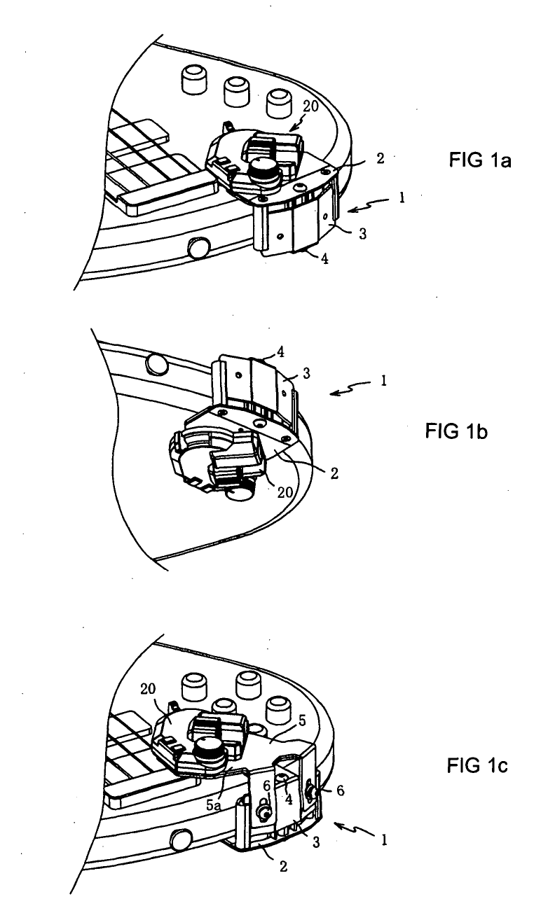

An explanation will be given below regarding a preferred embodiment of the present invention while referring to the attached drawings. FIGS. 1a, 1b and 1c show a main control unit 20 that uses an embodiment of the present invention in a mounted state on a bass guitar. The bass guitar is an example of a “stringed musical instrument,”with which embodiments of the invention may be employed. Other embodiments may operate with other suitable stringed musical instruments. FIG. 1a shows a case in which the main control unit 20 has been mounted on the front surface of the stringed musical instrument, FIG. 1b shows a case in which the main control unit 20 has been mounted on the rear surface of the stringed musical instrument, and FIG. 1c shows a case in which the main control unit 20 has been arranged above the bridge on the front side and mounted.

In the case of FIG. 1a, the main control unit 20 is affixed on a first holder 2. A bolt 4 is screwed down to hold the body of the stringed musical instrument between the first holder 2 and a second holder 3. The main control unit 20 is thereby mounted to the body of the stringed musical instrument.

In the case of FIG. 1b, the main control unit 20 is affixed on the first holder 2. The bolt 4 is screwed down to hold the body of the stringed musical instrument between the first holder 2 and the second holder 3. The main control unit 20 is thereby mounted to the body of the stringed musical instrument. However, the main control unit 20 is located on the rear surface of the body of the stringed musical instrument. In those cases where there is not sufficient space to mount the main control unit 20 on the front surface of the body of the stringed musical instrument, the main control unit 20 can be mounted using this method.

In the case of FIG. 1c, the body of the stringed musical instrument is held between the first holder 2 and the second holder 3 by screwing down the bolt 4, and a third holder 5 is fastened to the second holder 3 by a screw 6. The main control unit 20 is fastened to an attachment plate 5a that extends above the bridge of the stringed musical instrument.

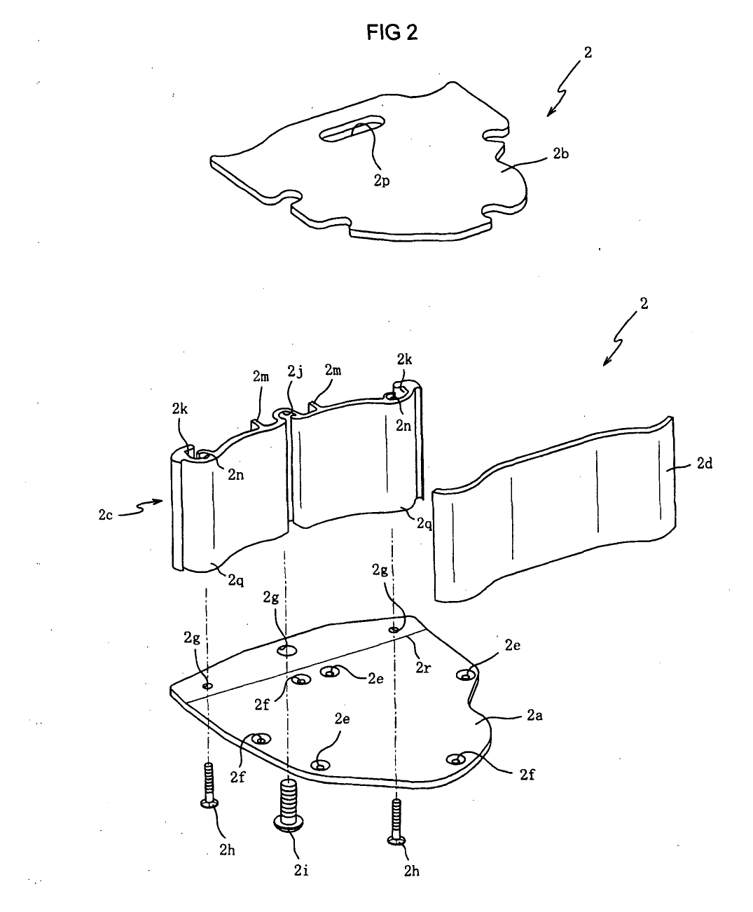

FIG. 2 is a disassembled oblique drawing of the first holder 2. The first holder 2 comprises a first contact plate 2a, a first cushion 2b that is affixed to the first contact plate 2a, a first side plate 2c that is screwed to the first contact plate 2a, and a second cushion 2d that is affixed to the first side plate 2c.

In an embodiment of the invention, the first cushion 2b is made of an elastic material characterized by a high coefficient of friction, and the second cushion 2d is made of a nonabrasive material. In a further embodiment of the invention, the first contact plate 2a is formed from a steel plate, the first cushion 2b is made of urethane foam, the first side plate 2c is an aluminum extrusion molded member, and the second cushion 2d is formed from felt.

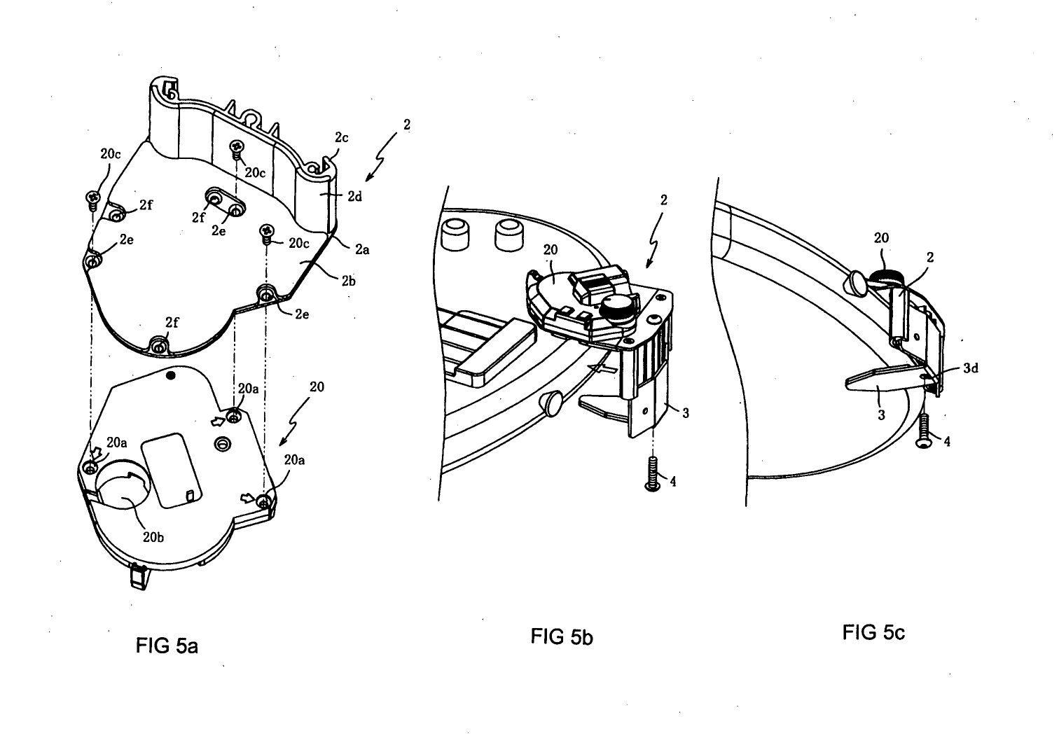

The first contact plate 2a has six screw holes 2e and 2f disposed in order to fasten the main control unit 20 using the flat screws 20c (refer to FIG. 5), and a hole 2p and various notches are formed in the portions of the first cushion 2b that correspond to the screw holes 2e and 2f so that the screws can be inserted. The three screw holes 2e from among these six screw holes are used in those cases where the main control unit is mounted on the front surface of the stringed musical instrument, and the remaining three screw holes 2f are used in those cases where the main control unit 20 is mounted on the rear surface of the stringed musical instrument. Three female threaded portions 20a are formed on the rear surface of the main control unit 20 (refer to FIG. 5).

The first contact plate 2a is bent on a straight line 2r near the attachment position at which the first side plate 2c is attached such that the first contact plate 2a forms an angle of less than 90 degrees with the first side plate 2c. In a further embodiment of the invention, the angle formed by the first contact plate 2a and the first side plate 2c is 88 degrees. The configuration is such that when the body of the stringed musical instrument is held between the first contact plate 2a and the second contact plate 3a, the elasticity of the first contact plate 2a (by bending on the straight line 2r of the first contact plate 2a) is utilized.

The first cushion 2b, which, in the further embodiment of the invention, has been formed from urethane foam, is affixed to the surface of the first contact plate 2a that is in contact with the body of the stringed musical instrument with an adhesive. Urethane foam is a material that prevents damage to the stringed musical instrument and has flexibility, which makes it possible to link the first holder 2 to the second holder 3 and to utilize the force of the pressing on the front surface of the body of the stringed musical instrument, thereby firmly holding the body of the stringed musical instrument between the first holder 2 and the second holder 3.

The body of the stringed musical instrument may have an arched front surface that has been formed such that the middle portion of the body is expanded. Because of the flexibility of the urethane foam, the first cushion 2b changes shape and adheres closely to the body of the stringed musical instrument. In addition, since the coefficient of friction of the urethane foam is large, it is possible to firmly hold the body of the stringed musical instrument, thereby reducing the possibility of sliding with respect to the body of the stringed musical instrument.

The first side plate 2c is screwed down by flat screws 2h and a round screw 2i along a direction roughly perpendicular to the first contact plate 2a. The surface of the first contact plate 2c that is in contact with the stringed musical instrument has a curved section disposed such that the surface follows along the curve of the side surface of the body of the stringed musical instrument. Convex sections 2q are formed on both ends of the curved section. Since the side surface of the body of the stringed musical instrument is curved, if the first side plate 2c is formed with a flat surface, the side surface of the stringed musical instrument and the first side plate 2c will be in contact in only one place, and it will not be stable. Therefore, by disposing the convex sections 2q on at least both ends of the curved section in this manner, there is contact in at least two places and it is possible to carry out the mounting in a stable state. The second cushion 2d that has been formed from felt in order to prevent damage to the body of the stringed musical instrument is affixed to the first side plate 2c with an adhesive.

Guide grooves 2k are disposed on both ends on the side of the first side plate 2c opposite to the side on which the second cushion 2d is affixed. The guide grooves 2k are disposed in a direction that is roughly perpendicular to the first contact plate 2a. In the middle of the first side plate 2c, there is a round hole 2j into which the bolt 4 and the round screw 2i are screwed. Two ribs 2m that are parallel to the round hole 2j on both sides of the round hole 2j are formed parallel to the guide grooves 2k. In addition, round holes 2n receive the flat screws 2h that are inserted into the screw holes 2g in the contact plate 2a. The round holes 2n are formed positioned near the vicinity of the guide grooves 2k. Threads are cut into the round holes 2n and the round hole 2j; in these holes, the flat screws 2h, the round screw 2i, and the bolt 4 are screwed down.

In assembling the first holder 2, the flat screws 2h and the round screw 2i are inserted into screw holes 2g of the first contact plate 2a and screwed into the round holes 2n and the round hole 2j of the first side plate 2c. In addition, the first cushion 2b is affixed to the first contact plate 2a, and the second cushion 2d is affixed to the first side plate 2c.

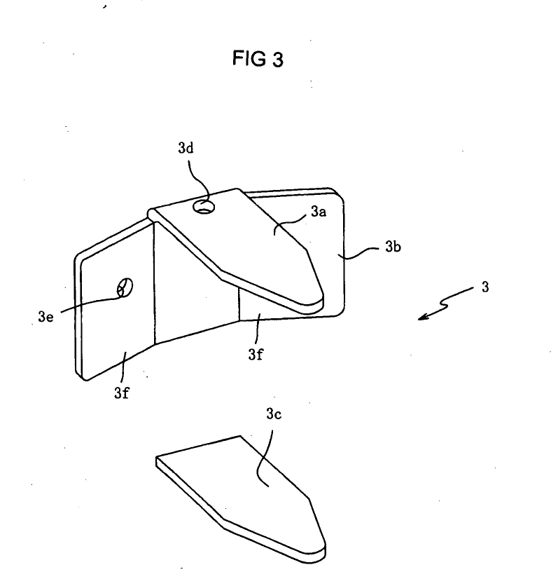

FIG. 3 is a disassembled oblique view drawing of the second holder 3. The second holder 3 comprises a second contact plate 3a, a second side plate 3b, and a third cushion 3c. The second contact plate 3a has an area that is smaller than that of the first contact plate 2a of the first holder 2 and is formed in a tongue shape with a tip shaped roughly as an isosceles triangle. The third cushion 3c is affixed to the surface that comes into contact with the stringed musical instrument. In a further embodiment of the present invention, the second contact plate 3a and the second side plate 3b are formed as a single unit by bending the second contact plate 3a from the second side plate 3b after the single unit is punched out of a steel plate or otherwise formed.

As was the case with the first holder 2, the bending angle of the second contact plate 3a and the second side plate 3b may be formed at about 88 degrees, and the configuration is such that when the body of the stringed musical instrument is held between the first contact plate 2a and the second contact plate 3a, the elasticity of the second contact plate 3a (by bending the second contact plate 3a from the second side plate 3b) is utilized.

In a further embodiment of the present invention, the third cushion 3c is, like the first cushion 2b, formed from urethane foam, thereby preventing damage to the stringed musical instrument. Due to the flexibility of the third cushion 3c, when the first holder 2 and the second holder 3 are linked, the pressing force on the front surface of the body of the stringed musical instrument is utilized, and it is possible to firmly hold the body of the stringed musical instrument between the first holder 2 and the second holder 3.

A screw hole 3d, which receives the bolt 4 for linking to the first holder 2, is formed at a position near the area at which the second side plate 3b of the second contact plate 3a is bent.

The second side plate 3b has two wings 3f that are inserted into guide grooves 2k that have been formed on both ends of the first side plate 2c. In a further embodiment of the invention, the two wings 3f are formed by bending the second side plate 3b such that the second side plate 3b follows the curvature of the first side plate 2c. Each of the two wings 3fand the surface that is between the two wings 3f are essentially flat surfaces and may be formed by press molding of steel plate. In addition, on each of the two wings 3f, female threads 3e, by which the third holder 5 is fastened, are disposed.

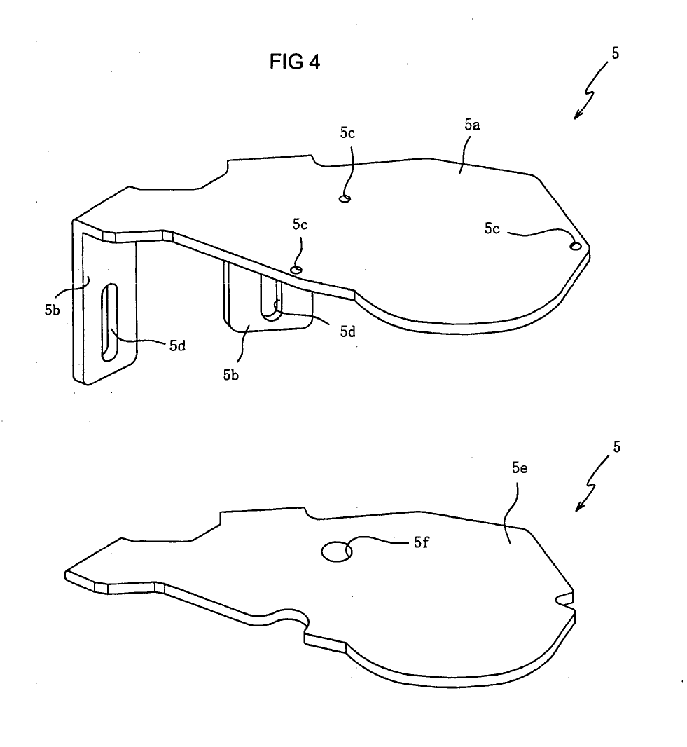

FIG. 4 is a disassembled oblique view drawing of the third holder 5. The third holder 5 comprises an attachment plate 5a, a fourth cushion 5e that is affixed to the attachment plate 5a, and two third side plates 5b that are disposed standing roughly perpendicular to the attachment plate 5a.

In a further embodiment of the invention, the attachment plate 5a and the two third side plates 5b are formed by bending a single unit stamped from steel plate, and the fourth cushion 5e is formed from felt. Three screw holes 5c, with which the main control unit 20 is fastened by flat screws 20c, are disposed on the attachment plate 5a. A hole 5f and various notches are formed in the portions of the fourth cushion Se that correspond to these screw holes 5c such that the screws can be inserted. Elongated holes 5d, which are elongated along a direction that is roughly perpendicular to the attachment plate 5a, are formed in each of the two third side plates 5b.

FIG. 5a, FIG. 5b, and FIG. 5cshow the details of the case that is shown in FIG. 1a in which the main control unit 20 is mounted on the front surface of the body of the stringed musical instrument. FIG. 5a shows a condition in which the main control unit 20 is mounted on the first holder 2. The flat screws 20c are inserted in the screw holes 2e in the first contact plate 2a and are screwed into the female threads 20a in the main control unit 20, thereby fastening the main control unit 20. The cylindrical open space 20b that accommodates the pickup cable 29 is formed in the bottom portion of the main control unit 20; and, in those cases where the pickup cable 29 is too long, it is possible to roll up the cable and store the cable in the open space 20b.

FIG. 5b shows a condition in which the main control unit 20 is fastened to the first holder 2. The two wings 3f of the second holder 3 are inserted into the guide grooves 2k of the first holder 2, the two ends of the second side plate 3b of the second holder 3 follow along the guide grooves 2k, the middle portion of the second side plate 3b slides along the ribs 2m, and the mounting is done such that the body of the stringed musical instrument is held between the first contact plate 2a and the second contact plate 3a.

FIG. 5c depicts a view from the rear side of the body of the stringed musical instrument of the state in which the first contact plate 2a is in contact with the front surface of the stringed musical instrument, the second contact plate 3a is in contact with the rear surface of the body of the stringed musical instrument, and the first side plate 2c is in contact with the side surface of the body of the stringed musical instrument. FIG. 5c also shows that the bolt 4 is inserted into the screw hole 3d in the second contact plate 3a and fastened to the female threads in the round hole 2j in the first side plate 2c. By screwing down the bolt 4, the first cushion 2b and the third cushion 3c, which are affixed, respectively, to the contact plate 2a of the first holder 2 and to the contact plate 3a of the second holder 3, are compressed. The body of the stringed musical instrument is held in a pressed state between them. In particular, when the first cushion 2b and the third cushion 3c are formed from urethane foam, which has a large coefficient of friction, the cushions and the body of the stringed musical instrument are closely pressed together, and firm fastening to the body of the stringed musical instrument is achieved.

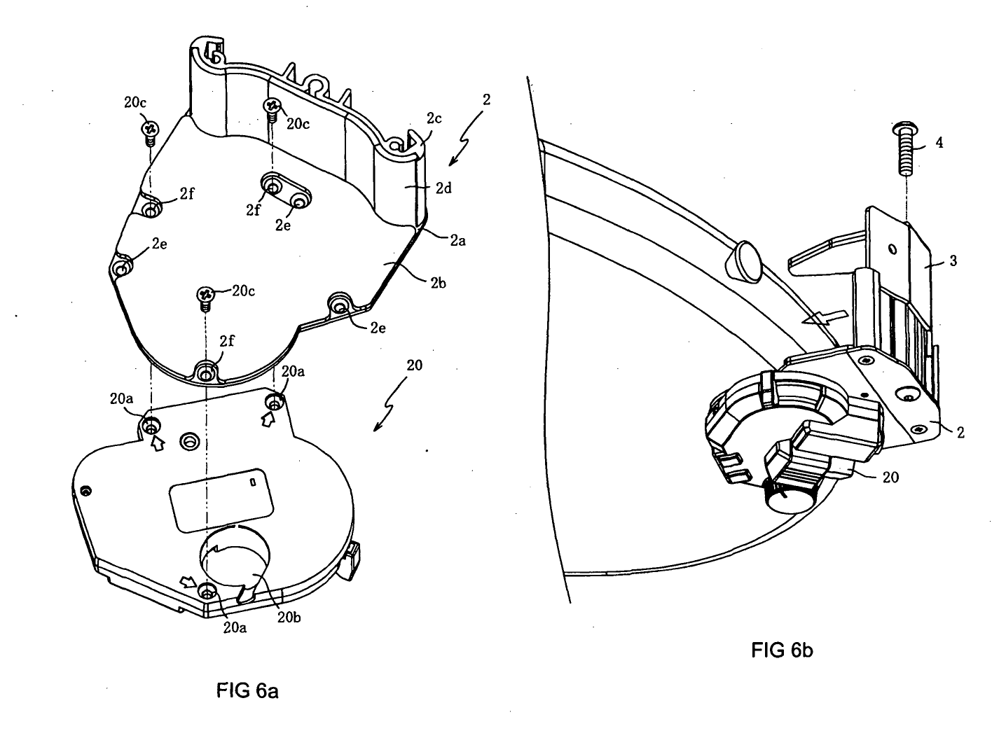

FIGS. 6a and 6b show the details of the case shown in FIG. 1a in which the main control unit 20 is mounted on the rear surface side of the body of the stringed musical instrument. FIG. 6a shows a condition in which the main control unit is mounted on the first holder 2. The flat screws 20c are inserted into the screw holes 2f in the first contact plate 2a and screwed down into the female threads 20a in the main control unit 20, fastening the main control unit 20. In those cases where the main control unit 20 is attached to the front surface of the stringed musical instrument in this manner and in those cases where the unit is attached to the rear surface of the stringed musical instrument, by changing the position on which the main unit 20 is mounted in the first holder 2, the connection cord with which the main control unit 20 is connected to the connector 23 is connected facing toward the lower rear.

FIG. 6b shows a condition in which the second holder 3 is mounted on the first holder 2 and the first and second holders are mounted on the stringed musical instrument. Since the method for linking the first holder 2 and the second holder 3 is the same as the case of the method shown in FIG. 2 in which the main control unit 20 is mounted on the front surface of the body of the stringed musical instrument, the description will be omitted.

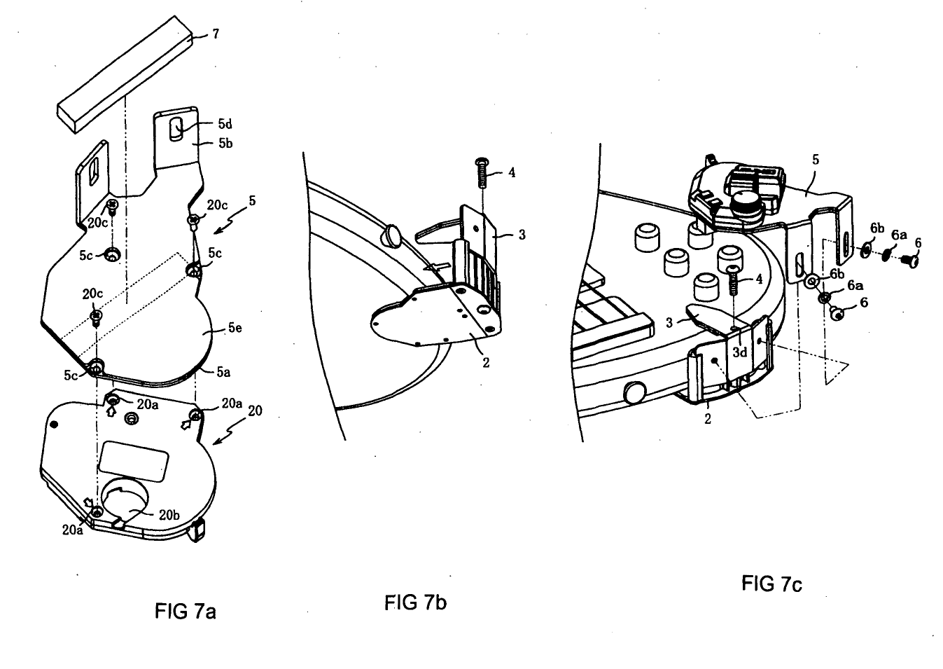

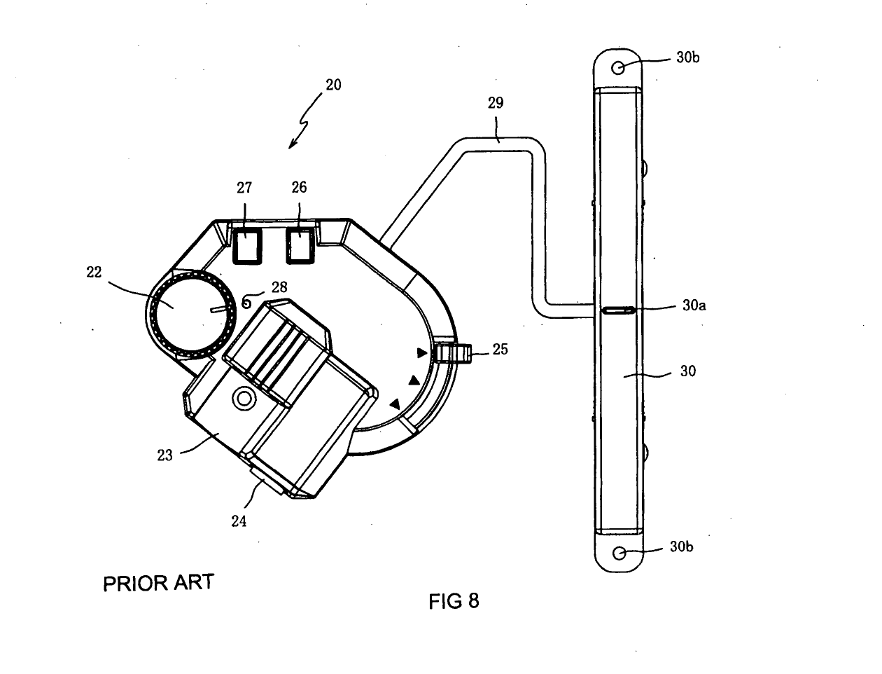

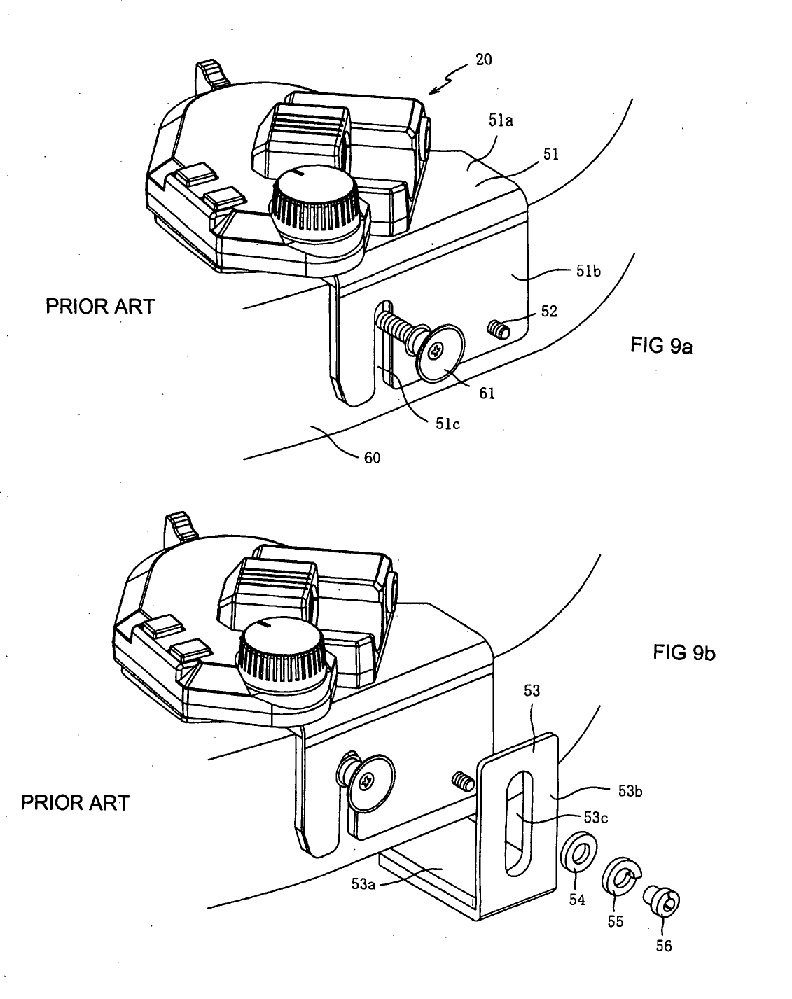

FIGS. 7a, 7b, and 7c show a condition in which the main control unit 20 is mounted above a bridge of the stringed musical instrument. FIG. 7a shows a condition in which the main control unit is fastened to the third holder 5. FIG. 7b shows a condition in which the second holder 3 is connected to the first holder 2 and the first and second holders are mounted on the stringed musical instrument. FIG. 7c shows a condition in which the third holder 5 is connected to the first holder 2 and the second holder 3.

FIG. 7a shows the condition in which the main control unit 20 is mounted on the third holder 5. When the third holder 5 is mounted on the body of the stringed musical instrument, a spacer 7 is affixed to the fourth cushion 5e and held between the cushion and the bridge so that the vibration of the strings is not impeded.

In a further embodiment of the present invention, the spacer 7 is made of foam rubber and affixed to the fourth cushion 5e by an adhesive. The flat screws 20c are inserted into the screw holes 5c in the attachment plate 5a, and the main control unit 20 is fastened to the upper surface of the attachment plate 5a.

FIG. 7b shows the condition in which the first contact plate 2a of the first holder 2 is in contact with the rear surface of the stringed musical instrument and the second contact plate 3a of the second holder 3 is in contact with the front surface of the stringed musical instrument and fastened to the stringed musical instrument. In this case, the two ends of the second side plate 3b of the second holder 3 follow along the guide grooves 2k, the middle portion of the second side plate 3b slides along the ribs 2m, and the mounting is done such that the body of the stringed musical instrument is held between the first contact plate 2a and the second contact plate 3a.

FIG. 7c shows the condition in which, as in FIG. 7b, the third holder 5, to which the main control unit 20 has been attached, is connected to the first holder 2 and the second holder 3 that have been mounted on the stringed musical instrument. First, the bolt 4 is inserted into the screw hole 3d on the second contact plate 3a and screwed into the female threads in the round hole 2j in the middle of the first side plate 2c. As a result, the body of the stringed musical instrument is held in a pressed state between the first holder 2 and the second holder 3.

Next, the elongated holes 5d on the side plates 5b of the third holder 5 are aligned with the female threads 3e in the second side plate 3b of the second holder 3 and the third holder 5 is disposed so that the spacer 7 is in contact with the bridge. In such a position, screws 6 are screwed down in two places along with flat washers 6b and spring washers 6a. In those cases where there is insufficient space to install the main control unit 20 close to the body of the stringed musical instrument, it is possible to mount the main control unit 20 above the bridge of the stringed musical instrument by using the third holder 5.

According to a preferred embodiment of the present invention, the main control unit 20 is fastened to the first holder 2 and by linking to the second holder 3 with the bolt 4, it is possible to easily mount the main control unit 20 on the front surface or the rear surface of the body of the stringed musical instrument. In addition, easy removal is possible by loosening the bolt 4 after mounting.

A further embodiment of the present invention addresses those cases where it is intended to mount the main control unit 20 on the front surface of the stringed musical instrument and where there is insufficient space on the front surface of the body of the stringed musical instrument. By assembling the third holder 5, it is possible to mount the control unit above the bridge of the stringed musical instrument.

An explanation was given above of embodiments of the present invention; however, the present invention is not limited to the specific embodiment described above. Various modifications and changes that do not deviate from and are within the scope of the essential aspects of the present invention can be easily surmised.

For example, in the specific embodiment, the bolt 4 that has been inserted in the screw hole 3d in the second holder 3 is coupled to the first side plate 2c that has been assembled on the first holder 2. As a result, the body of the stringed musical instrument is held between the first contact plate 2a and the second contact plate 3a. Conversely, a screw hole may be formed in the first holder 2 and female threads may be formed in the second side plate 3b of the second holder 3. By screwing in the bolt 4 through the screw hold in the first holder 2, the body of the stringed musical instrument is held between the first contact plate 2a and the second contact plate 3a.

What is claimed is:

1. An attachment apparatus for installing a main control unit on a stringed musical instrument having a front surface and a rear surface, the attachment apparatus comprising:
a first holder comprising a first contact plate in contact with the front surface or the rear surface of the stringed musical instrument and affixed to the main control unit;
a second holder comprising a second contact plate in contact with the rear surface or the front surface of the stringed musical instrument; and
a linking element linking the first holder and the second holder such that the stringed musical instrument is pressed between the first contact plate and the second contact plate.

2. The attachment apparatus according to claim 1, wherein the first holder further comprises a first side plate having a first end portion and a second end portion, wherein the first side plate is joined with the first contact plate such that a first angle is formed and wherein each of the first end portion and the second end portion of the first side plate includes at least one groove along an axis that intersects the joint of the first side plate and the first contact plate;
wherein the second holder further comprises a second side plate having a first end portion and a second end portion, wherein the second side plate is joined with the second contact plate such that a second angle is formed; and
wherein the first end portion of the second side plate slides along the at least one groove on the first end portion of the first side plate and the second end portion of the second side plate slides along the at least one groove on the second end portion of the first side plate.

3. The attachment apparatus according to claim 2, wherein the first angle is an acute angle.

4. The attachment apparatus according to claim 2, wherein the second angle is an acute angle.

5. The attachment apparatus according to claim 1, further comprising an elastic member either affixed to the first contact plate and disposed between the first contact plate and the stringed musical instrument or affixed to the second contact plate and disposed between the second contact plate and the stringed musical instrument.

6. The attachment apparatus according to claim 5, wherein the first elastic member and the second elastic member are formed from urethane foam.

7. The attachment apparatus according to claim 2, wherein the first side plate further comprises a curved surface that runs along a curvature of a side surface of the stringed musical instrument.

8. The attachment apparatus according to claim 7, wherein the curved surface of the first side plate comprises a first convex portion on the first end portion of the first side plate and a second convex portion on the second end portion of the first side plate and wherein both the first and the second convex portions contact the side surface of the stringed musical instrument.

9. The attachment apparatus according to claim 2, wherein the first side plate is formed by an extrusion molding of aluminum;
wherein the first side plate further comprises a curved surface that runs along a curvature of a side surface of the stringed musical instrument;
wherein the second side plate is formed by a press molding of steel plate; and
wherein the second side plate further comprises a plurality of flat surfaces, the plurality of flat surfaces arranged to generally conform in shape with the curved surface of the first side plate.

10. The attachment apparatus according to claim 2, wherein the first side plate further comprises a first hole formed along the axis that intersects the joint of the first side plate and the first contact plate;
wherein the second side plate comprises a second hole; and
and wherein the linking element comprises a bolt screwed through the first hole and the second hole.

11. An attachment apparatus for installing a main control unit on a stringed musical instrument having a front surface and a rear surface, the attachment apparatus comprising:
a first holder comprising a first contact plate in contact with the rear surface of the stringed musical instrument;
a second holder comprising a second contact plate in contact with the front surface of the stringed musical instrument and smaller in surface area than the first contact plate;
a linking element linking the first holder and the second holder such that the stringed musical instrument is pressed between the first contact plate and the second contact plate; and
a third holder comprising an attachment surface that is in contact with the main control unit,
wherein the third holder is connected to at least one of the first or the second holders and wherein the attachment surface of the third holder is disposed roughly parallel to the second contact plate of the second holder.

12. The attachment apparatus according to claim 11, wherein the first holder further comprises a first side plate having a first end portion and a second end portion, wherein the first side plate is joined with the first contact plate such that a first angle is formed and wherein each of the first end portion and the second end portion of the first side plate includes at least one groove along an axis that intersects the joint of the first side plate and the first contact plate;
wherein the second holder further comprises a second side plate having a first end portion and a second end portion, wherein the second side plate is joined with the second contact plate such that a second angle is formed; and
wherein the first end portion of the second side plate slides along the at least one groove on the first end portion of the first side plate and the second end portion of the second side plate slides along the at least one groove on the second end portion of the first side plate.

13. The attachment apparatus according to claim 12, wherein the first angle is an acute angle.

14. The attachment apparatus according to claim 12, wherein the second angle is an acute angle.

15. The attachment apparatus according to claim 11, further comprising an elastic member either affixed to the first contact plate and disposed between the first contact plate and the stringed musical instrument or affixed to the second contact plate and disposed between the second contact plate and the stringed musical instrument.

16. The attachment apparatus according to claim 15, wherein the first elastic member and the second elastic member are formed from urethane foam.

17. The attachment apparatus according to claim 12, wherein the first side plate further comprises a curved surface that runs along a curvature of a side surface of the stringed musical instrument.

18. The attachment apparatus according to claim 17, wherein the curved surface of the first side plate comprises a first convex portion on the first end portion of the first side plate and a second convex portion on the second end portion of the first side plate and wherein both the first and the second convex portions contact the side surface of the stringed musical instrument.

19. The attachment apparatus according to claim 12, wherein the first side plate is formed by an extrusion molding of aluminum;
wherein the first side plate further comprises a curved surface that runs along a curvature of a side surface of the stringed musical instrument;
wherein the second side plate is formed by a press molding of steel plate, and
wherein the second side plate further comprises a plurality of flat surfaces, the plurality of flat surfaces arranged to generally conform in shape with the curved surface of the first side plate.

20. The attachment apparatus according to claim 12, wherein the first side plate further comprises a first hole formed along the axis that intersects the joint of the first side plate and the first contact plate;
wherein the second side plate comprises a second hole; and
and wherein the linking element comprises a bolt screwed through the first hole and the second hole.

21. The attachment apparatus according to claim 1, wherein the main control unit comprises electronic circuits that receive a signal output from a pickup that detects vibration of a string of the stringed musical instrument.

22. The attachment apparatus according to claim 21, wherein the electronic circuits include a variable resistor; and
wherein the variable resistor receives the signal output by the pickup, adjusts the signal level of the signal, and outputs an adjusted signal.

23. The attachment apparatus according to claim 22, wherein the main control unit further comprises a connector through which the main control unit outputs the adjusted signal to an external device.

24. The attachment apparatus according to claim 11, wherein the main control unit comprises electronic circuits that receive a signal output from a pickup that detects vibration of a string of the stringed musical instrument.

25. The attachment apparatus according to claim 24, wherein the electronic circuits include a variable resistor; and
wherein the variable resistor receives the signal output by the pickup, adjusts the signal level of the signal, and outputs an adjusted signal.

26. The attachment apparatus according to claim 25, wherein the main control unit further comprises a connector through which the main control unit outputs the adjusted signal to an external device.

27. An apparatus for installing an external unit on a stringed musical instrument, the apparatus comprising:
a first holder comprising a first member disposed opposite to either a front surface of the stringed musical instrument or a rear surface of the stringed musical instrument;
a second holder comprising a second member, wherein, upon the first member being disposed opposite to the front surface of the stringed musical instrument, the second member is disposed opposite to the rear surface of the stringed musical instrument and wherein, upon the first member being disposed opposite to the rear surface of the stringed musical instrument, the second member is disposed opposite to the front surface of the stringed musical instrument; and
a linking member that links to a degree of tightness the first holder and the second holder,
wherein the external unit is attached to the apparatus; and
wherein a force by which the first holder and the second holder squeeze the front and the rear surfaces of the stringed musical instrument is proportional to the degree of tightness to which the linking member links the first and the second holders.

28. The apparatus according to claim 27, wherein the external unit is attached to the first member.

29. The apparatus according to claim 27, wherein the first holder further comprises a third member having a first end portion and a second end portion, wherein the first and the third members are joined along a first axis and wherein each of the first and the second end portions of the third member includes at least one groove along a second axis that intersects the first axis;
wherein the second holder further comprises a fourth member having a first end portion and a second end portion, wherein the fourth member is joined with the second member; and
wherein the fourth member is interlocked with the third member upon sliding the first end portion of the fourth member along the at least one groove on the first end portion of the third member and sliding the second end portion of the fourth member along the at least one groove on the second end portion of the third member.

30. The apparatus according to claim 27, further comprising:
a third holder comprising a third member; and
a second linking member that links the second holder and the third holder,
wherein the first member is disposed opposite to the rear surface of the stringed musical instrument and the second member is disposed opposite to the front surface of the stringed musical instrument; and
wherein the external unit is attached to the third member.

31. The apparatus according to claim 30,
wherein the first holder further comprises a fourth member having a first end portion and a second end portion, wherein the first and the fourth members are joined along a first axis and wherein each of the first and the second end portions of the fourth member includes at least one groove along a second axis that intersects the first axis;
wherein the second holder further comprises a fifth member having a first end portion and a second end portion, wherein the second member is joined with the fifth member;
wherein the fifth member is interlocked with the fourth member upon sliding the first end of the fifth member along the at least one groove on the first end of the fourth member and sliding the second end of the fifth member along the at least one groove on the second end of the fourth member;
wherein the third holder further comprises a sixth member;
wherein the second linking member links the sixth member to the fifth member; and
wherein the third member is disposed opposite to the front surface of the stringed musical instrument.

32. A method for installing an external unit on a stringed musical instrument, the method comprising steps of:
providing a first holder comprising a first member;
disposing the first member opposite to either a front surface of the stringed musical instrument or a rear surface of the stringed musical instrument;
providing a second holder comprising a second member, wherein, upon the first member being disposed opposite to the front surface of the stringed musical instrument, the second member is disposed opposite to the rear surface of the stringed musical instrument, and wherein, upon the first member being disposed opposite to the rear surface of the stringed musical instrument, the second member is disposed opposite to the front surface of the stringed musical instrument; and
linking to a degree of tightness the first holder and the second holder,
wherein a force by which the first holder and the second holder squeeze the front and the rear surfaces of the stringed musical instrument is proportional to the degree of tightness to which the first and the second holders are linked; and
wherein the external unit is installed on the stringed musical instrument via the linked first and second holders.

33. The method according to claim 32, wherein the external unit is installed on the stringed musical instrument by attaching the external unit to the first member.

34. The method according to claim 32, further comprising steps of:
joining along a first axis the first member with a third member of the first holder;
joining the second member with a fourth member of the second holder; and
interlocking the fourth member with the third member,
wherein the third member has a first end portion and a second end portion, wherein each of the first and the second end portions of the third member includes at least one groove along a second axis that intersects the first axis;
wherein the fourth member has a first end portion and a second end portion; and
wherein the interlocking of the fourth member with the third member occurs upon sliding the first end portion of the fourth member along the at least one groove on the first end portion of the third member and sliding the second end portion of the fourth member along the at least one groove on the second end portion of the third member.

35. The method according to claim 32, further comprising steps of:
providing a third holder comprising a third member; and
linking the second holder and the third holder,
wherein the first member is disposed opposite to the rear surface of the stringed musical instrument and the second member is disposed opposite to the front surface of the stringed musical instrument; and
wherein the external unit is installed on the stringed musical instrument by attaching the external unit to the third member.

36. The method according to claim 35, further comprising steps of:
joining along a first axis the first member with a fourth member of the first holder;
joining the second member with a fifth member of the second holder; and
interlocking the fifth member with the third member,
wherein the fourth member has a first end portion and a second end portion, wherein each of the first and the second end portions of the fourth member includes at least one groove along a second axis that intersects the first axis;
wherein the fifth member has a first end portion and a second end portion;
wherein the interlocking of the fifth member with the fourth member occurs upon sliding the first end portion of the fifth member along the at least one groove on the first end portion of the fourth member and sliding the second end portion of the fifth member along the at least one groove on the second end portion of the fourth member;
wherein the linking of the second holder and the third holder comprises linking the fifth member with a sixth member of the third holder; and
wherein the third member is disposed opposite to the front surface of the stringed musical instrument.
